(19) United States
(12) Patent Application Publication
(10) Pub. No.: US 2025/0215274 A1
(43) Pub. Date: Jul. 3, 2025

(54) COMPOSITE FILM AND METHOD OF MANUFACTURING COPPER FOIL SUBSTRATE USING THE SAME

(71) Applicant: TAIMIDE TECHNOLOGY INCORPORATION, Hsinchu Hsien (TW)

(72) Inventors: CHENG-CHENG TSAI, Hsinchu Hsien (TW); CHUNG-YEN HSU, Hsinchu Hsien (TW)

(73) Assignee: TAIMIDE TECHNOLOGY INCORPORATION, Hsinchu Hsien (TW)

(21) Appl. No.: 18/981,684

(22) Filed: Dec. 16, 2024

(30) Foreign Application Priority Data
Dec. 29, 2023 (TW) 112151605

(51) Int. Cl. C09J 7/38; B32B 7/12; B32B 15/08; B32B 27/28; C09J 7/25; C09J 11/08

(52) U.S. Cl. CPC C09J 7/38; B32B 7/12; B32B 15/08; B32B 27/281; C09J 7/25; C09J 11/08; B32B 2250/02; B32B 2307/748; C09J 2203/326; C09J 2301/408

(57) ABSTRACT

Provides a composite film and a method of manufacturing copper foil substrate using the composite film. The composite film includes a support membrane; and an adhesive composition formed on the support membrane. The adhesive composition includes polyimide and a liquid crystal polymer filler. The polyimide is composed of a dianhydride and a diamine, the dianhydride includes at least a bisphenol A diether dianhydride (BPADA) residue, and the diamine includes at least a diamine having an ether group structure. A weight percentage of the liquid crystal polymer filler in the adhesive composition ranges from 30 wt % to 50 wt %, a ratio of a glass transition temperature TgB of the polyimide to a melting point temperature TmA of the liquid crystal polymer filler (TgB/TmA) is less than 0.6, and a dissipation factor (Df) of the composite film is less than 0.005.

### CROSS-REFERENCE TO RELATED APPLICATION

This non-provisional application claims priority under 35 U.S.C. § 119 (a) on Patent Application No(s). 112151605 filed in Taiwan, R.O.C. on Dec. 29, 2023, the entire contents of which are hereby incorporated by reference.

### BACKGROUND OF THE INVENTION

### 1. Field of the Invention

The present disclosure relates to a composite film and a method of manufacturing copper foil substrate using the composite film, and in particular to a composite film having a dissipation factor of less than 0.005 and a peeling strength with respect to the copper foil of greater than 0.8 Kgf/cm² under an electromagnetic wave frequency of 10 GHz and a relative humidity RH of 50%.

### 2. Description of the Related Art

With the rapid development of high-frequency and high-speed communication applications, the demand for materials suitable for high-frequency and high-speed flexible copper clad laminates (FCCL) and flexible printed circuit boards (FPC) has increased. The mainstream non-fluorine-based materials in the market are liquid crystal polymer materials and polyimides.

The fluorine-based polymers are the mostly used materials in the high-frequency applications. However, due to the rise of environmental awareness (such as the EU Perfluorinated and Polyfluorinated Alkyl Substances (PFAS) issue), there is a tendency to restrict the wide-scale use of excellent high-frequency application materials that cannot be decomposed for a long time in the manufacturing of 3C products, so the non-fluorine high-frequency materials are becoming increasingly important.

### BRIEF SUMMARY OF THE INVENTION

However, although pure liquid crystal polymer materials have excellent electrical properties, their adhesion to copper foil, mechanical and thermal properties are poor, which not only makes the FCCL and FPC processes have high technical threshold, low yield, and high cost, but also leads to market monopoly. Polyimide has excellent mechanical and thermal properties required in the processing of FCCL and FPC, and its adhesion to copper foil is also very good, so almost most FCCL and FPC factories have mature processing techniques. Polyimide is not excellent enough in electrical performance only, which makes it unable to be applied to high-frequency communication requirements greater than 10 GHz (20˜100 GHz). The current development of polyimide for high-frequency applications has reached the limit of material properties. When trying to improve polyimide for high-frequency applications, special monomer raw materials must be used, resulting in increased development costs and low price competitiveness.

For the application to flexible substrates (FCCL), dissipation factor and the adhesion to copper foil layer are the two most important material applications factors that must be considered for the back-end processes. Dissipation factor and adhesion are two important indicators in terms of materials. In the future, it is necessary to invent a material that is excellent in both these two properties.

The present disclosure provides a composite film and a method of manufacturing copper foil substrate using the composite film. The composite film includes a support membrane; and an adhesive composition formed on the support membrane. The adhesive composition includes polyimide and a liquid crystal polymer filler. The polyimide is composed of a dianhydride and a diamine, the dianhydride includes at least a bisphenol A diether dianhydride (BPADA) residue, and the diamine includes at least a diamine having an ether group structure. A weight percentage of the liquid crystal polymer filler in the adhesive composition ranges from 30 wt % to 50 wt %, a ratio of a glass transition temperature TgB of the polyimide to a melting point temperature TmA of the liquid crystal polymer filler (TgB/TmA) is less than 0.6, and a dissipation factor (Df) of the composite film is less than 0.005.

### BRIEF DESCRIPTION OF THE DRAWINGS

FIG. 1 is a schematic view showing a composite film of the present disclosure.

FIG. 2 is a schematic view showing a method of manufacturing a copper foil substrate using the composite film according to the present disclosure.

### DETAILED DESCRIPTION OF THE INVENTION

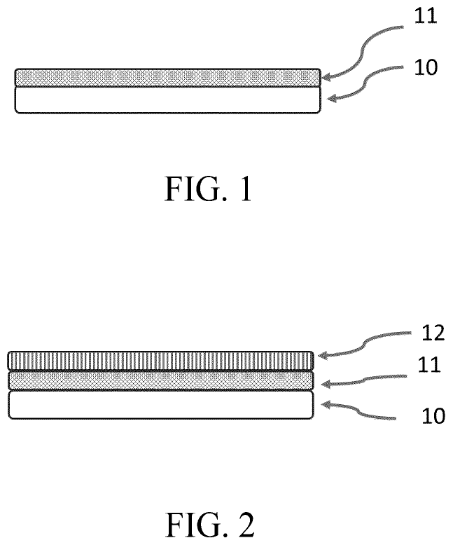

With reference to FIG. 1 and FIG. 2, which are schematic views showing a composite film of the present disclosure and a method of manufacturing a copper foil substrate using the composite film. The composite film includes:
a support membrane 10, which may be a polyimide membrane, a composite film of a liquid crystal polymer and polyimide, or a composite film of a fluorine-based polymer and polyimide;
an adhesive composition 11 formed on the support membrane 10 and including polyimide and a liquid crystal polymer filler, wherein the polyimide is composed of a dianhydride and a diamine, the dianhydride includes at least a bisphenol A diether dianhydride (BPADA) residue, the diamine includes at least a diamine having an ether group structure, and a weight percentage of the liquid crystal polymer filler in the adhesive composition ranges from 30 wt % to 50 wt %;
wherein a ratio of a glass transition temperature TgB of the polyimide to a melting point temperature TmA of the liquid crystal polymer filler (TgB/TmA) is less than 0.6, and a dissipation factor (Df) of the composite film is less than 0.005.

The diamine having the ether group structure has a chemical formula structure below, wherein n is 1 to 2:

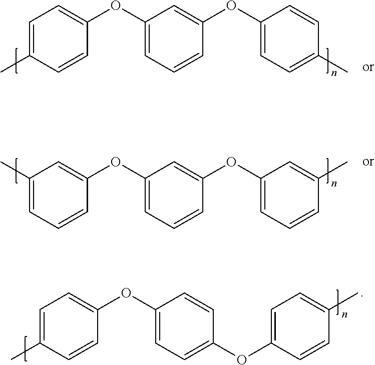

The liquid crystal polymer filler ideally has a dissipation factor of less than 0.001, more ideally less than 0.0009, and even more ideally less than 0.0008.

The cumulative 50% particle size D₅₀ of the particle size distribution of the liquid crystal polymer filler is 20 μm or less, and the cumulative 99% particle size D₉₉ is or less than 2.5 times the D₅₀.

The melting temperature (Tm) of the liquid crystal polymer filler is ideally between 27° and 330° C., more ideally between 30° and 330° C., and even more ideally between 31° and 330° C.

The water absorption rate of the liquid crystal polymer filler is ideally less than 0.5%, and more ideally less than 0.05%.

The adhesive composition is evenly mixed with a dehydrating agent and a catalyst, coated on a support membrane, and then subject to chemical cyclization, or the adhesive composition undergoes direct thermal hardening without adding the dehydrating agent and the catalyst. Finally, it is baked and cured at high temperature to form a composite film.

The dehydrating agent of the chemical cyclization described above may be acetic anhydride; the catalyst may be pyridine, 3-methylpyridine, 2-methylpyridine, 4-methylpyridine, isoquinoline, quinoline, triethylamine, among which pyridine, 3-methylpyridine, 2-methylpyridine and 4-methylpyridine are preferred. In the present disclosure, 3-methylpyridine is selected as the catalyst.

The high-temperature baking and curing temperature conditions used in the method of making the composite film may be 80 to 90° C. to bake for 20 to 40 minutes, then the temperature is raised to 170° C. to bake for 20 to 30 minutes, then the temperature is raised to 250° C. to bake for 30 to 60 minutes, and finally the temperature is raised to 310˜350° C. to bake for 20 to 30 minutes.

A metal copper foil 12 is pre-laminated on one or both sides of the composite film at a temperature of 320 to 340° C., and then laminated at high pressure and high temperature to form a copper foil substrate.

The copper foil may be a rolled copper foil, an electrolytic copper foil, a copper foil with low surface roughness, or a copper foil with various surface treatments (roughening, rust prevention, etc.). Examples of anti-rust treatment include electroplating treatment containing Ni, Zn, Sn, etc., chromate treatment, etc. The thickness of the copper foil is not particularly limited, but is ideally 1-100 μm, and more ideally 1-50 μm.

The lamination conditions used for the composite film are: a pressure of 60 kgf/cm² and an ideal temperature of 280˜340° C., preferably 320˜340° C., for 20 minutes, followed by reduction to 180˜200° C. and a pressure of 15˜20 kgf/cm² for 10 minutes. The actual temperature conditions may be fine-tuned based on the glass transition temperature TgB.

In the following, the present disclosure is specifically illustrated based on the examples, but the present disclosure is not limited thereto. Furthermore, details of the raw materials represented by abbreviations in each example are presented below.

### Raw Materials of Adhesive Composition:

Bisphenol A diether dianhydride: BPADA
3,3′,4,4′-biphenyltetracarboxylic dianhydride: BPDA
Pyromellitic dianhydride: PMDA
Diamines containing an ether group structure: TPER, TPEQ, APBN
4,4′-diaminodiphenyl ether: ODA
p-phenylenediamine: PDA
Liquid crystal polymer filler: LF-31P liquid crystal polymer powder, developed and manufactured by ENEOS Company

### Solvent

DMAc: Dimethylacetamide

AA: acetic anhydride

AP: 3-methylpyridine

### <Detection Method>

The following methods were used to measure various properties of the adhesive composition, composite film and copper clad laminate obtained in the following examples.

Dissipation factor: According to the ASTM D2520 standard method, the E5071C network analyzer manufactured by Agilent is used, and the resonant cavity is distributed by Waveray. The measurement is carried out under the conditions having a relative humidity RH of 50% and a frequency of 10 GHz. The average value of three measurements is taken as the actual value.

Glass transition temperature (TgB): According to the IPC-TM-650 specification, the model Q400 TMA instrument produced by TA Instruments is used, and the heating rate is set to 10° C./min for measurement.

Melting temperature (TmA): According to the ASTM D3418 specification, the DSC200F3 instrument produced by NETZSCH is used for measurement.

Peeling strength: According to the IPC TM 650 specification, the Tinius Olsen company's model 10ST universal material testing machine is used for measurement.

### Example 1

### Preparation of Composite Films

Polymerize was performed to form 120 g of polyimide precursor. 12.1 g of APBN was added into 86.4 g of DMAc solvent, followed by evenly stirring for dissolution, and then 21.0 g of BPADA was added. The reaction temperature was controlled at 25° C., and the stirring was continued to react for 2-3 hr. A trace amount of BPADA was used to fine-tune the viscosity, and finally a polyimide precursor with a solid content of 28.0% and a viscosity of 160000±40000 cps was obtained. 25.1 g of the DMAc solvent containing 25.0 g of the polyimide precursor (that is, the solid substance (polyimide) in the polyimide precursor was about 7.0 g) were mixed and stirred evenly with 3.0 g of the liquid crystal polymer filler, and then a mixture of the catalyst and the dehydrating agent was added thereto, in which the mixture of the catalyst and the dehydrating agent was composed of 2.7 g of AA, 1.3 g of AP and 4.0 g of DMAc solution. Finally, an adhesive composition with a total solid content of 16.5% was obtained. After uniform mixing, it was degassed by centrifugation, coated on a support membrane (polyimide film was used here), baked at 80˜90° C. for 20 minutes, heated to 170° C. and baked for 30 minutes, then heated to 250° C. and baked for 60 minutes, and finally heated to 330° C. and baked for 20 minutes to form a composite film.

### Preparation of Copper Foil Substrate

A composite film that is 10 cm in both length and width was taken. Both sides of the composite film were covered with a copper foil, which was 15 cm in both length and width. The composite film was subject to lamination under a pressure of 60 kgf/cm² and a temperature of 310° C. for 15 minutes, followed by a reduced temperature of 190° C. and a pressure of 15 kgf/cm² for 10 minutes, finally forming a copper foil substrate.

### Example 2

The preparation method of the composite film was the same as in Example 1, except that the weight of the liquid crystal polymer filler added was changed to 4.7 g.

The preparation method and conditions of the copper foil substrate were the same as in Example 1.

### Example 3

The preparation method of the composite film was the same as in Example 1, except that the weight of the liquid crystal polymer filler added was changed to 7.2 g.

The preparation method and conditions of the copper foil substrate were the same as in Example 1.

### Example 4

The preparation method of the composite film was the same as in Example 1, except that 12.1 g of APBN was changed to addition of 12.1 g of TPER.

The preparation method of the copper foil substrate was the same as in Example 1.

### Example 5

The preparation method of the composite film was the same as in Example 1, except that 12.1 g of APBN was changed to addition of 12.1 g of TPEQ, and the weight of the liquid crystal polymer filler added was changed to 7.2 g.

The preparation method and conditions of the copper foil substrate were the same as in Example 1.

### Example 6

The preparation method of the composite film was the same as in Example 1, except that 12.1 g of APBN was changed to addition of 11.2 g of TPER and 0.4 g of PDA, and the weight of the liquid crystal polymer filler added was changed to 7.2 g.

The preparation method and conditions of the copper foil substrate were the same as in Example 1.

### Example 7

The preparation method of the composite film was the same as in Example 1, except that 12.1 g of APBN was changed to addition of 11.5 g of TPER and 0.3 g of PDA, and the weight of the liquid crystal polymer filler added was changed to 7.2 g.

The preparation method and conditions of the copper foil substrate were the same as in Example 1.

### Example 8

The preparation method of the composite film was the same as in Example 1, except that 12.4 g of TPER, 20.0 g of BPADA and 1.1 g of BPDA were added instead, and the weight of the liquid crystal polymer filler added was changed to 7.2 g.

The preparation method and conditions of the copper foil substrate were the same as in Example 1.

### Example 9

The preparation method of the composite film was the same as in Example 1, except that 12.4 g of TPER, 20.1 g of BPADA, 0.57 g of BPDA and 0.42 g of PMDA were added instead, and the weight of the liquid crystal polymer filler added was changed to 7.2 g.

The preparation method and conditions of the copper foil substrate were the same as in Example 1.

### Example 10

The preparation method of the composite film was the same as in Example 1, except that 12.3 g of TPER, 20.1 g of BPADA and 0.74 g of BPDA were added instead, and the weight of the liquid crystal polymer filler added was changed to 7.2 g.

The preparation method and conditions of the copper foil substrate were the same as in Example 1.

### Example 11

The preparation method of the composite film was the same as in Example 1, except that 11.4 g of TPER, 0.5 g of ODA and 21.7 g of BPADA were added instead, and the weight of the liquid crystal polymer filler added was changed to 7.2 g.

The preparation method and conditions of the copper foil substrate were the same as in Example 1.

### Example 12

The preparation method of the composite film was the same as in Example 1, except that 9.7 g of TPER, 3.3 g of ODA, 1.8 g of PDA and 18.9 g of BPADA were added instead, and the weight of the liquid crystal polymer filler added was changed to 7.2 g.

The preparation method and conditions of the copper foil substrate were the same as in Example 1.

### Comparative Example 1

The preparation method of the composite film was the same as in Example 1, except that the weight of the liquid crystal polymer filler added was changed to 1.8 g.

The preparation method and conditions of the copper foil substrate were the same as in Example 1.

### Comparative Example 2

The preparation method of the composite film was the same as in Example 1.

The preparation method of the copper foil substrate was the same as in Example 1, except that the maximum lamination temperature was changed to 310° C.

### Comparative Example 3

The preparation method of the composite film was the same as in Example 1.

The preparation method of the copper foil substrate was the same as in Example 1, except that the maximum lamination temperature was changed to 350° C.

### Comparative Example 4

The preparation method of the composite film was the same as in Example 1, except that the weight of the liquid crystal polymer filler added was changed to 16.8 g.

The preparation method of the copper foil substrate was the same as in Example 1.

### Comparative Example 5

The preparation method of the composite film was the same as in Example 1, except that 10.1 g of TPER, 0.9 g of PDA and 22 g of BPADA were added instead.

The preparation method and conditions of the copper foil substrate were the same as in Example 1.

### Comparative Example 6

The preparation method of the composite film was the same as in Example 1, except that 13.1 g of TPER, 1.9 g of PMDA and 18.6 g of BPADA were added instead.

The preparation method and conditions of the copper foil substrate were the same as in Example 1.

The table for comparison between Examples and Comparative Examples is as follows.

TABLE 1

| | Dianhydride 1 | | Dianhydride 2 | | Dianhydride 3 | | Diamine 1 | | Diamine 2 | | Diamine 3 | |
|---|---|---|---|---|---|---|---|---|---|---|---|---|
| | (mol %) | | (mol %) | | (mol %) | | (mol %) | | (mol %) | | (mol %) | |
| Example 1 | BPADA | 100 | | | | | APBN | 100 | — | | | |
| Example 2 | BPADA | 100 | | | | | APBN | 100 | — | | | |
| Example 3 | BPADA | 100 | | | | | APBN | 100 | | | | |
| Example 4 | BPADA | 100 | | | | | TPER | 100 | | | | |
| Example 5 | BPADA | 100 | | | | | TPEQ | 100 | | | | |
| Example 6 | BPADA | 100 | | | | | TPER | 91 | PDA | 9 | | |
| Example 7 | BPADA | 100 | | | | | TPER | 94 | PDA | 6 | | |
| Example 8 | BPADA | 91 | BPDA | 9 | | | TPER | 100 | | | | |
| Example 9 | BPADA | 91 | BPDA | 4.5 | PMDA | 4.5 | TPER | 100 | | | | |
| Example 10 | BPADA | 94 | BPDA | 6 | | | TPER | 100 | | | | |
| Example 11 | BPADA | 100 | | | | | TPER | 94 | ODA | 6 | | |
| Example 12 | BPADA | 100 | | | | | TPER | 94 | ODA | 4.5 | PDA | 4.5 |
| Comparative | BPADA | 100 | | | | | APBN | 100 | | | | |
| Example 1 | | | | | | | | | | | | |
| Comparative | BPADA | 100 | | | | | APBN | 100 | | | | |
| Example 2 | | | | | | | | | | | | |
| Comparative | BPADA | 100 | | | | | APBN | 100 | | | | |
| Example 3 | | | | | | | | | | | | |
| Comparative | BPADA | 100 | | | | | APBN | 100 | | | | |
| Example 4 | | | | | | | | | | | | |
| Comparative | BPADA | 100 | | | | | APBN | 80 | PDA | 20 | | |
| Example 5 | | | | | | | | | | | | |
| Comparative | BPADA | 80 | PMDA | 20 | | | APBN | 100 | | | | |
| Example 6 | | | | | | | | | | | | |

| | | | | Maximum | | Dissipation |
|---|---|---|---|---|---|---|
| | | Liquid crystal | | lamination | Peeling | factor (Df) |
| | Polyimide | polymer filler | | temperature | strength | @ 50% RH |
| | Wt % | Wt % | Tg/Tm | ° C. | Kgf/cm | 10 GHz |
| Example 1 | 70 | 30 | 0.52 | 330 | 1.00 | 0.0049 |
| Example 2 | 60 | 40 | 0.52 | 330 | 0.99 | 0.0047 |
| Example 3 | 50 | 50 | 0.52 | 330 | 0.95 | 0.0039 |
| Example 4 | 50 | 50 | 0.58 | 330 | 0.88 | 0.0041 |
| Example 5 | 50 | 50 | 0.59 | 330 | 0.86 | 0.0046 |
| Example 6 | 50 | 50 | 0.59 | 330 | 0.83 | 0.0046 |
| Example 7 | 50 | 50 | 0.59 | 330 | 0.84 | 0.0044 |
| Example 8 | 50 | 50 | 0.59 | 330 | 0.85 | 0.0046 |
| Example 9 | 50 | 50 | 0.59 | 330 | 0.83 | 0.0048 |
| Example 10 | 50 | 50 | 0.58 | 330 | 0.85 | 0.0043 |
| Example 11 | 50 | 50 | 0.53 | 330 | 0.85 | 0.0044 |
| Example 12 | 50 | 50 | 0.53 | 330 | 0.85 | 0.0045 |
| Comparative | 80 | 20 | 0.51 | 330 | 1.20 | 0.0057 |
| Example 1 | | | | | | |
| Comparative | 50 | 50 | 0.51 | 330 | 0.40 | 0.0041 |
| Example 2 | | | | | | |
| Comparative | 50 | 50 | 0.51 | 330 | 0.56 | 0.0040 |
| Example 3 | | | | | | |
| Comparative | 30 | 70 | 0.51 | 330 | 0.52 | 0.0032 |
| Example 4 | | | | | | |
| Comparative | 50 | 50 | 0.72 | 330 | 0.50 | 0.0060 |
| Example 5 | | | | | | |
| Comparative | 50 | 50 | 0.75 | 330 | 0.55 | 0.0066 |
| Example 6 | | | | | | |

Comparative Example 1: Because the solid weight percentage of the liquid crystal polymer filler added in the adhesive composition is less than 30%, the dissipation factor of the composite film is greater than 0.005.

Comparative Example 2: Because the maximum lamination temperature is less than 320° C., the peeling strength between the composite film and the copper foil is less than 0.8 Kgf/cm.

Comparative Example 3: Because the maximum lamination temperature is greater than 340° C., the peeling strength between the composite film and the copper foil is less than 0.8 Kgf/cm.

Comparative Example 4: Because the solid weight percentage of the liquid crystal polymer filler added in the adhesive composition is more than 50%, the peeling strength between the composite film and the copper foil is less than 0.8 Kgf/cm.

Comparative Example 5: Because the mole percentage of the added diamine without an ether group structure is greater than 20%, the dissipation factor is greater than 0.005 and the peeling strength is less than 0.8 Kgf/cm.

Comparative Example 6: Because the molar percentage of the added PMDA in the dianhydride is more than 20%, the dissipation factor is greater than 0.005 and the peeling strength is less than 0.8 Kgf/cm.

As shown in Table 1, it can be confirmed that the composite film prepared by the adhesive composition manufactured according to the examples of the present disclosure has a dissipation factor of less than 0.005, and the peeling strength between the composite film and copper foil in the copper clad laminate formed through lamination of the composite film is greater than 0.8 Kgf/cm.

The content of the above specific embodiments is to illustrate the present invention in detail. However, these embodiments are only for illustration and are not intended to limit the present invention. Those skilled in the art can understand that various changes or modifications made to the present invention without departing from the scope defined in the appended claims fall within a part of the present invention.

While the present disclosure has been described by means of specific embodiments, numerous modifications and variations could be made thereto by those skilled in the art without departing from the scope and spirit of the present disclosure set forth in the claims.

What is claimed is:

1. A composite film, which is used to be laminated with a copper foil at 320˜340° C. for achieving a peeling strength of greater than 0.8 Kgf/cm, comprising:
a support membrane;
an adhesive composition formed on the support membrane and including polyimide and a liquid crystal polymer filler, wherein the polyimide is composed of a dianhydride and a diamine, the dianhydride comprises at least a bisphenol A diether dianhydride (BPADA) residue, the diamine comprises at least a diamine having an ether group structure, and the diamine having the ether group structure comprises a chemical formula structure below, wherein n is 1 to 2; 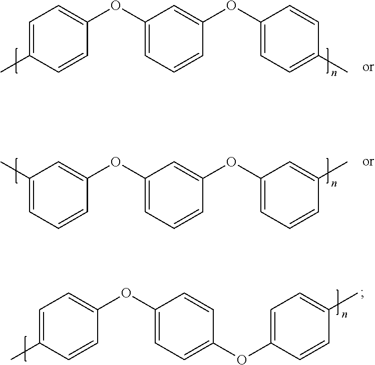
a weight percentage of the liquid crystal polymer filler in the adhesive composition ranges from 30 wt % to 50 wt %; a ratio of a glass transition temperature TgB of the polyimide to a melting point temperature TmA of the liquid crystal polymer filler (TgB/TmA) is less than 0.6, and a dissipation factor (Df) of the composite film is less than 0.005.

2. The composite film of claim 1, wherein the support membrane is a polyimide membrane.

3. The composite film of claim 1, wherein the dianhydride further comprises a pyromellitic dianhydride (PMDA) residue, of which a mole percentage in the dianhydride is less than 10%.

4. The composite film of claim 1, wherein the dianhydride further comprises a 3,3′,4,4′-biphenyltetracarboxylic dianhydride (BPDA) residue, of which a mole percentage in the dianhydride is less than 10%.

5. The composite film of claim 1, wherein the dianhydride further comprises a 3,3′,4,4′-biphenyltetracarboxylic dianhydride (BPDA) residue and a pyromellitic dianhydride (PMDA) residue, of which each mole percentage in the dianhydride is less than 10%.

6. The composite film of claim 1, wherein the diamine further comprises a p-phenylenediamine (PDA) residue, of which a mole percentage in the diamine is less than 10%.
